(19) United States
(12) Patent Application Publication
(10) Pub. No.: US 2026/0248134 A1
(43) Pub. Date: Aug. 27, 2026

(54) A METHOD FOR CONTROLLING WEEDS

(71) Applicants: UPL MAURITIUS LIMITED, Port Louis (MU); UPL EUROPE SUPPLY CHAIN GMBH, Rotkreuz/Risch (CH)

(72) Inventors: Ayrton NETO, Campinas (BR); Luciano Hohmann ZANOTTO, Campinas (BR); Jessica LEAL, Pereiras (BR); Paulo Eduardo Rezende SIMINO, Campinas (BR); Rafael ROVEA, Campinas (BR)

(21) Appl. No.: 19/163,021

(22) PCT Filed: Mar. 8, 2024
(86) PCT No.: PCT/EP2024/056280

§ 371 Date: Sep. 8, 2025

(30) Foreign Application Priority Data
Mar. 9, 2023 (IN) 202331015669

(51) Int. Cl. A01N 47/24; A01N 25/04; A01N 25/14; A01N 43/80; A01P 13/00

(52) U.S. Cl. CPC A01N 47/24; A01N 25/04; A01N 25/14; A01N 43/80; A01P 13/00

(57) ABSTRACT

The present disclosure relates to a method for controlling weeds, wherein the method comprises applying an effective amount of a herbicidal combination/composition comprising a carbamate herbicide.

### FIELD OF THE DISCLOSURE

The present disclosure relates to a method for controlling weeds. More particularly, the present disclosure relates to a method for controlling weeds by applying an effective amount of a herbicidal combination/composition comprising a carbamate herbicide.

### BACKGROUND OF THE DISCLOSURE

Herbicides are agrochemicals that are used to control growth of undesired plants/weeds, which can be detrimental to the crop growth, health and yield. Traditionally, herbicides have been selected for their weed-controlling characteristics as well as for their effect on crops. Herbicides that control a broad spectrum of weed species often have limited utility because they also injure crops. Additionally, often the most desirable herbicides for weed control and crop safety have other less desirable characteristics (e.g., environmental and economic concerns). Therefore, a desirable herbicide should control a broad spectrum of weeds, while causing no harm to the desired plants; and also dissipate from the soil rapidly after weed control is accomplished.

Unwanted plants/weeds can be controlled using herbicides that are either selective or non-selective in nature. Non-selective herbicides damage all plants to which they are applied, i.e., both desired and undesired vegetation. In contrast, selective herbicides eliminate or inhibit the growth of unwanted vegetation, while leaving the desired vegetation relatively unharmed. Selective herbicides are designed to control specific broadleaf or grassy weeds, while leaving desired plants unharmed. These herbicides have low to moderate toxicity and do not cause damage to the crops. Various selective herbicides are known in the art for the selective control of grass and broadleaf weeds growing in a variety of crops. The majority of these herbicides are synthetic compounds, with some herbicides raising concerns in recent years as to their safety to humans and the environment in general.

One of the known disadvantages of selective herbicides is their slow speed of activity. Often herbicidal activity is not seen for several months after application. Moreover, the herbicides often do not provide adequate weed control with one application, resulting in the need for additional applications of the same herbicide or another herbicide in order to achieve acceptable weed control. Furthermore, these selective herbicides present major toxicological and environmental concerns. Therefore, it is required to use selective herbicides that are effective in providing weed control, yet environmentally safe. Thus, there is presently a need for safer alternatives for currently used selective herbicides. There also exists a need for an environmentally safe herbicide that can selectively control unwanted plants, preferably grasses and broadleaf weeds, while leaving other plants and crops relatively unharmed.

### Objectives of the Disclosure

It is a primary objective of the present disclosure to provide a method for efficient weed control, weed suppression and eradication.

It is another objective of the present disclosure to provide a method for selective weed control by applying an effective amount of a herbicidal combination/composition comprising a carbamate herbicide.

It is another objective of the present invention to provide a method for burn-down control of weeds by applying an effective amount of a herbicidal combination/composition comprising a carbamate herbicide.

It is another objective of the present invention to provide a method to control, suppress or prevent a wide spectrum of weeds and target plants, both dicotyledonous and monocotyledonous, broad-leaved, and grassy weeds, by applying an effective amount of a herbicidal combination/composition comprising a carbamate herbicide.

It is another objective of the present invention to provide a method for controlling weeds by applying an effective amount of a herbicidal combination/composition comprising a carbamate herbicide, which is safe to use, effective and can be applied pre-emergence, post-emergence or at the time of sowing.

### SUMMARY OF THE DISCLOSURE

In one aspect, the present disclosure provides a method for controlling weeds by applying an effective amount of a carbamate herbicide.

In another aspect, the present disclosure provides a method for controlling weeds by applying an effective amount of a herbicidal combination comprising a carbamate herbicide and an additional herbicide thereof.

In another aspect, the present disclosure provides a method for controlling by applying an effective amount of a herbicidal combination comprising a carbamate herbicide and at least one adjuvant thereof.

Additional features and advantages of the present disclosure will be apparent from the detailed description that follows, which illustrates by way of example, the most preferred features of the present disclosure which are not to be construed as limiting the scope of the disclosure described herein.

### DETAILED DESCRIPTION OF THE DISCLOSURE

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

It is to be noted that, as used in the specification, the singular forms “a”, “an”, and “the” include plural referents unless the context clearly dictates otherwise. Thus, for example, reference to a composition containing “a compound” includes a mixture of two or more compounds. It should also be noted that the term “or” is generally employed in its sense including “and/or” unless the content clearly dictates otherwise. The terms “preferred” and “preferably” refer to embodiments of the disclosure that may afford certain benefits, under certain circumstances.

As used herein, the terms “comprising”, “having”, “including”, “containing” and “involving” are to be construed as open-ended terms (i.e., meaning “including, but not limited to”) unless otherwise noted. In any aspect or embodiment described hereinbelow, the phrase comprising may be replaced by the phrases “consisting of” or “consisting essentially of” or “consisting substantially of”. In these aspects or embodiment, the combination or composition described “includes” or “comprises” or “consists of” or “consists essentially of” or “consists substantially of” the specific components recited therein, to the exclusion of other herbicides or fungicides or insecticides or plant growth promoting agents or adjuvants, or excipients not specifically recited therein.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

The expression of various quantities in terms of “%” or “% w/w” means the mass concentration of the particular ingredient in the composition/combination unless otherwise specified.

As used herein, the terms “kg a.i./ha” or “kg/ha” as used herein denote the concentration of the respective active ingredient in “kilograms” applied “per hectare” of the crop field. As used herein, the terms “g a.i./ha” or “g/ha” as used herein denote the concentration of the respective active ingredient in “grams” applied “per hectare” of the crop field.

As used herein, the terms “about” or “approximately” are inclusive of the stated value and means within an acceptable range of deviation for the particular value as determined by one of ordinary skilled in the art, considering the measurement in question and the error associated with measurement of the particular quantity (i.e., the limitations of the measurement system). For example, “about” can mean within one or more standard deviations, or within ±10% or ±5% of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. It is understood that where a parameter range is provided, all integers within that range, and tenths thereof, are also provided. For example, “0.1-80%” includes 0.1%, 0.2%, 0.3%, etc. up to 80%.

As used herein, the term “agrochemical” used herein is understood to denote an agricultural chemical such as pesticides, fungicides, insecticides, acaricides, herbicides, nematicides, plant growth regulators and can be used interchangeably.

As used herein, the term “agrochemically acceptable salt” means a salt which is acceptable for use in agrochemical or horticultural use. The salts referred to herein are agrochemically acceptable salts.

As used herein, the term “herbicide” as used herein means an active ingredient that kills, controls or otherwise adversely modifies the growth of unwanted plants. As used herein, a “herbicidally effective amount” is an amount of active ingredient that causes a “herbicidal effect” i.e., an adversely modifying effect and includes deviations from natural development, killing, regulation, desiccation, retardation, and methods known to a person skilled in the art.

As used herein the term “plant” or “crop” refers to whole plants, plant organs (e.g., leaves, stems, twigs, roots, trunks, limbs, shoots, fruits etc.), plant cells, and plant seeds. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolon, and buds and other parts of plants, including seedlings and young plants, which are to be transplanted after germination or after emergence from soil.

As used herein, the term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

As used herein, the term “seed” embraces seeds and plant propagules of all kinds including but not limited to true seeds, seed pieces, suckers, corms, bulbs, fruit, tubers, grains, cuttings, cut shoots and the like. In a preferred embodiment a seed is a true seed.

As used herein, the term “increased yield” of an agricultural plant means that the yield of a product of the respective plant is increased by a measurable amount over the yield of the same product of the plant produced under the same conditions, but without the application of the compositions described herein. According to the present disclosure, it is preferred that the crop yield be increased by at least 0.5%, preferably at least 2%, more preferably at least 5%, upon application of the combinations and compositions described herein.

The term “weed” as used herein refers to the plant whose growth is considered undesirable in a particular situation i.e., growth of a plant at a wrong place and includes pesticide resistant plants. In the broadest sense, the term “weed” refers to plants which grow in locations in which they are not desired. In other words, a “weed” is a plant in which in the context of a crop is undesirable due to competition for water, nutrients, sunlight, soil, etc. The term may also refer to crop plants which are undesirable at a location. As used herein, the terms “undesirable vegetation”, “harmful plants”, “unwanted plants”, “weeds” and “weed species”, as used herein, are synonyms.

Typically, the combinations/compositions of the present disclosure are applied to the targeted weed or to their locus or to the crop/plant. The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus. The said locus could be a weed, an area adjacent to the weed, soil adapted to support growth of the weed, a root of the weed and/or foliage of the weed.

As used herein, the term “fallow” is used to denote an arable agricultural land which is kept uncultivated for less than one, one or more vegetative cycle, due to weather conditions not appropriate to crops, time between one cultivated crop and another or to rejuvenate the quality of soil and regain its nutrient content. “Chemical fallow” as used herein refers to the treatment of agricultural land with any chemical/herbicide to keep the land free from the growth of weeds, at the time of rejuvenation or no crop or post emergence of any crop.

As used herein, the term “post-emergence” refers to the application of a herbicidal combination or a composition after emergence of a plant from the soil. As used herein, the term “pre-emergence” refers to the time point before seedlings emerge from the ground. When any herbicide is applied at pre-emergence stage, it prevents establishment of the germinated weed seedlings.

As used herein, the terms “formulation” and “composition” may be used interchangeably and refer to a mixture of two or more compounds, elements, molecules, etc. In some aspects, the terms formulation and composition may be used to refer to a mixture of one or more ingredients with a carrier or other excipients.

As used herein, the term “phytotoxicity” refers to any adverse effect or reaction on plant growth, physiology, or metabolism caused by any chemical substance, fertilizer, herbicide, heavy metal, etc.

As used herein, the terms “excipient” or “additive” mean inactive substance that forms a part of the composition. The terms “excipient” or “additive” mean essentially the same thing and can be used interchangeably.

According to an embodiment, the present disclosure provides a method for controlling weeds by applying an effective amount of a carbamate herbicide, wherein the weeds comprise broadleaf and grass weeds.

In another embodiment, the present disclosure provides a method for controlling herbicide-resistant and/or herbicide-tolerant weeds. In another embodiment, the present disclosure provides a method for controlling herbicide-resistant and/or herbicide-tolerant weeds in fallow fields.

In yet another embodiment, the carbamate herbicide is selected from the group comprising asulam, barban, 1-methylpropyl (3-chlorophenyl)carbamate (BCPC), carbasulam, carbetamide, carboxazole, 2-chloroethyl (3-chlorophenyl)carbamate (CEPC), chlorbufam, 2-chloro-1-methylethyl (3-chlorophenyl)carbamate (CPPC), dichlormate, famoxacarb, fenasulam, propham, swep, terbucarb, or combinations thereof.

In a preferred embodiment, the carbamate herbicide is asulam.

In another embodiment, the present disclosure provides a method for controlling weeds by application of asulam.

In another embodiment, the present disclosure provides a method for controlling herbicide-resistant and/or herbicide-tolerant weeds by application of asulam.

In an embodiment, the present disclosure provides a method for controlling weeds, wherein the method comprises applying an effective amount of a carbamate herbicide.

In another embodiment, the present disclosure provides a method for controlling weeds, wherein the method comprises applying an effective amount of asulam.

In another embodiment, the present disclosure provides a method for controlling weeds by application of an effective amount of the herbicidal combination to a plant, or a plant propagation material, or a locus thereof.

In another embodiment, the present disclosure provides a method for controlling weeds by applying an effective amount of a herbicidal combination comprising asulam and an adjuvant thereof.

In an embodiment, the present disclosure provides a method for controlling weeds, wherein the weeds are controlled by applying concurrently or subsequently or sequentially a herbicidal combination comprising asulam and an adjuvant thereof.

In an embodiment, the adjuvant is selected from the group comprising nonyl phenol ethylene oxide condensate non-ionic organic surfactant, any adjuvant classified as mineral oil and one or more mono alkyl esters of fatty acids selected from the group consisting wheat germ methyl ester, wheat germ ethyl ester, wheat germ propyl ester, corn oil methyl ester, soybean oil methyl ester, soybean oil ethyl ester, soybean oil propyl ester, coconut oil methyl ester, coconut oil ethyl ester, coconut oil propyl ester, cotton seed oil methyl ester, cotton seed oil ethyl ester, cotton seed oil propyl ester, corn oil ethyl ester, corn oil propyl ester, sunflower oil methyl ester, sunflower oil ethyl ester, sunflower oil propyl ester, safflower oil methyl ester, safflower oil ethyl ester, safflower oil propyl ester, rapeseed oil methyl ester, rapeseed oil ethyl ester, rapeseed oil propyl ester, mustard oil methyl ester, mustard oil ethyl ester, mustard oil propyl ester, castor oil methyl ester, castor oil ethyl ester, castor oil propyl ester, sesame oil methyl ester, sesame oil ethyl ester, sesame oil propyl ester, pine oil methyl ester, pine oil ethyl ester, pine oil propyl ester, linseed oil methyl ester, linseed oil ethyl ester, linseed oil propyl ester, jatropha methyl ester, jatropha ethyl ester, jatropha propyl ester, algae methyl ester, algae ethyl ester, algae propyl ester, tallow methyl ester, tallow ethyl ester, tallow propyl ester, methyl palmitate, ethyl palmitate, propyl palmitate, methyl stearate, ethyl stearate, propyl stearate, methyl oleate, ethyl oleate, propyl oleate, methyl linoleate, ethyl linoleate, propyl linoleate, isopropyl myristate, or combinations thereof.

In a preferred embodiment, the adjuvant is present in an amount of about 200 g/L.

In another embodiment, the present disclosure provides a method for controlling weeds by applying an effective amount of a herbicidal combination comprising asulam and an additional agrochemical thereof.

In an embodiment, the present disclosure provides a method for controlling weeds, wherein the weeds are treated by applying concurrently or subsequently or sequentially a herbicidal combination comprising asulam and an additional agrochemical thereof.

In an embodiment, the additional agrochemical comprises at least one pesticide selected from the group comprising acaricides, algicides, avicides/bird repellents, bactericides, fungicides, herbicide safeners, herbicides, insect attractants, insect chemosterilants, insect repellents, insecticides, mammal repellents, molluscicides, nematicides, nitrification inhibitors, plant activators, plant growth regulators, rodenticides, synergists, virucides, and combinations thereof.

In an embodiment, the additional agrochemical is a herbicide.

In an embodiment, the present disclosure provides a method for controlling weeds by applying an effective amount of a herbicidal combination comprising asulam and an additional herbicide thereof.

In a preferred embodiment, the additional herbicide is present in an amount of about 500 g/L.

In an embodiment, the additional herbicide is selected from the group comprising aliphatic acid herbicides, amide herbicides, aromatic acid herbicides, benzofuran herbicides, benzonitrile herbicides, benzophenone herbicides, benzothiadiazinone herbicides, benzyl ether herbicides, botanical herbicides, carbamate herbicides, cyclohexanedione oxime herbicides, dinitroaniline herbicides, dinitrophenol herbicides, diphenyl ether herbicides, diphenyl heterocycle herbicides, dithiocarbamate herbicides, fumigant herbicides, halogenated alkanoic acid herbicides, imidazolinone herbicides, inorganic herbicides, isoxazole herbicides, isoxazolidinone herbicides, isoxazoline herbicides, N-phenyl heterocycle herbicides, N-phenylimide herbicides, N-phenyloxadiazolone herbicides, N-phenyltriazolinone herbicides, organochlorine herbicides, organophosphorous herbicides, oxirane herbicides, oxyacetamide herbicides, phenol herbicides, phenoxy herbicides, phenylcarboxylic acid herbicides, phenyl ether herbicides, phenylthiourea herbicides, pyrazole herbicides, pyridazine herbicides, pyridazinone herbicides, pyridine herbicides, pyrimidinediamine herbicides, pyrimidinyloxybenzylamine herbicides, quaternary ammonium herbicides, quinone herbicides, alpha-thioacetamide herbicides, thiocarbamate herbicides, thiocarbonate herbicides, triazine herbicides, triazinone herbicides, triazole herbicides, triazolone herbicides, triazolopyrimidine herbicides, triketone herbicides, uracil herbicides, urea herbicides, unclassified herbicide, and combinations thereof.

In an embodiment, the additional herbicide is further selected from the group comprising phosphinic acid herbicides, sulfonylaminocarbonyltriazolinone herbicides, anilide herbicides, acetamide herbicides, aryloxyphenoxypropionic herbicides, benzoylpyrazole herbicides, chloroacetamide herbicides, glycine derivative herbicides, aryloxyphenoxypropionic herbicides, phenyl ether herbicides, N-phenylimide herbicides, imidazolinone herbicides, N-phenyltriazolinone herbicides, alkylazine herbicides, phenoxyacetic herbicides, pyridyloxycarboxylic acid herbicides, benzoic acid herbicides, triketone herbicides, chlorotriazine herbicides, quaternary ammonium herbicides, phenylurea herbicides, phenylpyrazoline herbicides, and combinations thereof.

In a preferred embodiment, the additional herbicide is selected from the group comprising pyroxasulfone, glufosinate, glufosinate-P, flucarbazone, mesotrione, propanil, napropamide, napropamide-M, quizalofop, quizalofop-P, haloxyfop, haloxyfop-P, topramezone, saflufenacil, amicarbazone, metolachlor, S-metolachlor, pendimethalin, clomazone, glyphosate, paraquat, clethodim, triclopyr, and combinations thereof.

In another preferred embodiment, the additional herbicide is selected from the group comprising diflufenican, propisochlor, flumioxazin, imazethapyr, sulfentrazone, indaziflam, 2,4-dichlorophenoxyacetic acid (2,4-D), fluroxypyr, halauxifen, dicamba, tembotrione, atrazine, diquat, florpyrauxifen, terbuthylazine, diuron, pinoxaden, epyrifenacil, tiafenacil, and combinations thereof.

According to an embodiment, the herbicidal combination comprises asulam in a concentration from about 100 g/L to about 900 g/L and preferably from about 300 g/L to about 800 g/L.

In a preferred embodiment, the additional herbicide is present in an amount of about 750 g/L.

According to an embodiment, a weight ratio of asulam to an adjuvant in the herbicidal combination ranges from about 1:100 to about 100:1.

In an embodiment, the weight ratio of asulam to the adjuvant is selected from ratios comprising 1:100, 1:90, 1:80, 1:70, 1:60, 1:50, 1:40, 1:30, 1:20 and 1:10. In an embodiment, the weight ratio of asulam to adjuvant is selected from ratios comprising 10:1, 20:1, 30:1, 40:1, 50:1, 60:1, 70:1, 80:1, 90:1 and 100:1.

In another embodiment, the weight ratio of asulam to the adjuvant in the herbicidal combination ranges from about 1:50 to about 50:1.

In another embodiment, the weight ratio of asulam to the adjuvant in the herbicidal combination ranges from about 1:30 to about 30:1.

In another embodiment, the weight ratio of asulam to the adjuvant in the herbicidal combination ranges from about 1:10 to about 10:1.

In a preferred embodiment, the weight ratio of asulam to the adjuvant is about 3.75:1.

According to an embodiment, a weight ratio of asulam to an additional herbicide in the herbicidal combination ranges from about 1:100 to about 100:1.

In an embodiment, the weight ratio of asulam to the additional herbicide is selected from ratios comprising 1:100, 1:90, 1:80, 1:70, 1:60, 1:50, 1:40, 1:30, 1:20 and 1:10. In an embodiment, the weight ratio of asulam to the additional herbicide is selected from ratios comprising 10:1, 20:1, 30:1, 40:1, 50:1, 60:1, 70:1, 80:1, 90:1 and 100:1.

In another embodiment, the weight ratio of asulam to the additional herbicide in the herbicidal combination ranges from about 1:50 to about 50:1.

In another embodiment, the weight ratio of asulam to the additional herbicide in the herbicidal combination ranges from about 1:30 to about 30:1.

In another embodiment, the weight ratio of asulam to the additional herbicide in the herbicidal combination ranges from about 1:10 to about 10:1.

In a preferred embodiment, the weight ratio of asulam to the additional herbicide is about 1.5:1.

In another embodiment, the present disclosure provides a method for controlling weeds by applying an effective amount of a herbicidal composition comprising asulam and at least one agrochemically acceptable excipient thereof.

In another embodiment, the present disclosure provides a method for controlling herbicide-resistant and/or herbicide-tolerant weeds by application of a herbicidal composition comprising asulam and at least one agrochemically acceptable excipient thereof.

According to an embodiment, the present disclosure provides a method for controlling weeds, wherein the weeds are treated by applying concurrently or subsequently or sequentially a herbicidal composition asulam and at least one agrochemically acceptable excipient thereof.

In another embodiment, the present disclosure provides a method for controlling weeds by application of an effective amount of the herbicidal composition to a plant, or a plant propagation material, or a locus thereof.

According to an embodiment, the herbicidal composition comprises asulam in an amount from about 10% w/w to about 95% w/w, preferably from about 30% w/w to about 90% w/w, more preferably from about 50% w/w to about 85% w/w of total weight of the composition.

According to an embodiment, herbicidal composition comprises the agrochemically acceptable excipient in an amount from about 1% w/w to about 30% w/w of total weight of the composition.

According to an embodiment, the herbicidal composition comprises asulam in an amount from about 30% w/w to about 90% w/w and agrochemically acceptable excipients in an amount from about 1% w/w to about 30% w/w of total weight of the composition.

In an embodiment, the herbicidal composition comprises asulam in an amount from about 50% w/w to about 85% w/w and agrochemically acceptable excipient in an amount from about 1% w/w to about 30% w/w of total weight of the composition.

According to an embodiment, the present disclosure relates to a herbicidal composition comprising asulam and at least one agrochemically acceptable excipient thereof; wherein the herbicidal composition is in a form of a solid or a liquid formulation.

In an embodiment, the herbicidal composition is selected from capsule suspension (CS), dispersible concentrate (DC), emulsifiable concentrate (EC), emulsion, water in oil (EO), emulsion, oil in water (EW), micro-emulsion (ME), oil dispersion (OD), oil miscible flowable concentrate (oil miscible suspension (OF), oil miscible liquid (OL), suspension concentrate (SC), suspoemulsion (SE), soluble concentrate (SL), water dispersible granule (WG or WDG), water soluble granule (SG), water soluble powder (SP), wettable powder (WP), flowable concentrate (FS), and combinations thereof.

In a preferred embodiment, the present disclosure relates to a herbicidal composition comprising asulam and at least one agrochemically acceptable excipient thereof; wherein the herbicidal composition is a soluble concentrate (SL).

In a preferred embodiment, the present disclosure relates to a herbicidal composition comprising asulam and at least one agrochemically acceptable excipient thereof; wherein the herbicidal composition is a water dispersible granule (WG or WDG).

In a preferred embodiment, the herbicidal composition is in a form of a soluble concentrate (SL) or a water dispersible granule (WG or WDG).

According to an embodiment, the herbicidal composition comprising asulam is present either in a form of a tank mix or a pre-formulated (pre-mix) composition.

In an embodiment, the herbicidal composition comprising asulam is present in a form of a tank mix composition.

In an embodiment, the herbicidal composition comprising asulam is present in a form of a pre-formulated (pre-mix) composition.

According to an embodiment, the herbicidal composition comprising asulam and at least one agrochemically acceptable excipient thereof; further comprises an additional agrochemical.

In a preferred embodiment, the herbicidal composition comprising asulam and at least one agrochemically acceptable excipient thereof; further comprises an additional herbicide.

According to an embodiment, the herbicidal composition comprises an additional agrochemical in an amount from about 1% w/w to about 80% w/w of total weight of the composition.

In another embodiment, the herbicidal composition comprises an additional herbicide in an amount from about 1% w/w to about 80% w/w, preferably from about 1% w/w to about 50% w/w of total weight of the composition.

According to an embodiment, the present disclosure provides a method for controlling weeds, wherein the herbicidal combination/composition comprising asulam is applied in a range from about 10 g a.i./ha to about 5000 g a.i./ha, preferably from about 10 g a.i./ha to about 3000 g a.i./ha, preferably from about 10 g a.i./ha to about 1500 g a.i./ha, and more preferably from about 100 g a.i./ha to about 500 g a.i./ha.

In a preferred embodiment, asulam is applied at about 1000 g a.i./ha asulam is applied at about 1200 g a.i./ha; asulam is applied at about 1500 g a.i./ha; asulam is applied at about 1800 g a.i./ha; asulam is applied at about 2250 g a.i./ha; asulam is applied at about 2400 g a.i./ha asulam is applied at about 2500 g a.i./ha; asulam is applied at about 2800 g a.i./ha; asulam is applied at about 3200 g a.i./ha; asulam is applied at about 3600 g a.i./ha; asulam is applied at about 4000 g a.i./ha; and asulam is applied at about 4500 g a.i./ha.

According to an embodiment, the present disclosure provides for a method for controlling weeds, wherein the herbicidal combination/composition comprising asulam is applied in a range from about 1 to about 50 kg/ha, preferably from about 1 to about 30 kg/hay, and more preferably from about 1 to about 10 kg/ha.

In an embodiment, the present disclosure provides a method for controlling weeds, preferably broadleaf weeds and grass weeds.

In a preferred embodiment, the weeds may be selected from the group of Poaceae weeds comprising Echinochloa crusgalli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spicaventi, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum or Rottboellia cochinchinensis, and combinations thereof.

In a preferred embodiment, the weeds may be selected from the group comprising Avena sp., Avena sativa, Avena strigosa, Ageratum conyzoides, Bidens pilosa, Bidens subalternans, Brachiaria brizantha (currently known as Urochloa brizantha), Brachiaria decumbens (currently known as Urochloa decumbens), Brachiaria extensa (currently known as Urochloa platyphylla), Brachiaria plantaginea (currently known as Urochloa plantaginea), Cenchrus echinatus, Chloris gayana, Chloris sp., Conyza sp., Commelina benghalensis, Commelina elegans, Cynodon dactylon, Digitaria insularis, Digitaria horizontalis, Digitaria sanguinalis, Digitaria Nuda, Echinochloa crus-galli, Echinochloa sp., Eleusine ssp., Eragrostis ciliaris, Eragrostis Pilosa, Leptochloa filiformis, Melinis minutiflora, Melinis repens, Murdannia nudiflora, Panicum fasciculatum, Panicum purpurascens, Panicum maximum, Paspalum dilatatum, Paspalum virgatum, Pennisetum purpureum, Pennisetum setosum, Poa annua, Raddia stolonifera, Rhynchelytrum repens, Rottboellia exaltata, Spermacoce verticillata, Spermacoce latifolia, Spermacoce spinosa, Setaria spp., Sorghum halepense, Sorghum sudanense, Sporobolus indicus, Tridax procumbens, and unwanted plants growing in a particular crop field such as volunteer Glycine max, volunteer Zea mays, volunteer cotton, volunteer wheat, other volunteer crops, and combinations thereof.

In a preferred embodiment, the weeds may be selected from the group comprising Avena strigosa, Ipomoea hederifolia, Raphanus raphanistrum, Ambrosia artemisifolia, Megathyrsus maximus, Digitaria insularis, Eleusine indica, Cynodon dactylon, Digitaria nuda, Bidens Pilosa, Brachiaria plantaginea, and combinations thereof.

In a preferred embodiment, the weeds may be selected from the group comprising Avena strigosa, Ipomoea hederifolia, Raphanus raphanistrum, Ambrosia artemisifolia, Megathyrsus maximus, and combinations thereof.

In a preferred embodiment, the weeds are controlled from about 10% to about 100% by applying an effective amount of a carbamate herbicide.

In another embodiment, the present disclosure provides a method for controlling Avena strigose, wherein the method comprises applying an effective amount of a herbicidal combination/composition comprising asulam.

In another embodiment, the present disclosure provides a method for controlling Ipomoea hederifolia, wherein the method comprises applying an effective amount of a herbicidal combination/composition comprising asulam.

In another embodiment, the present disclosure provides a method for controlling Raphanus raphanistrum, wherein the method comprises applying an effective amount of a herbicidal combination/composition comprising asulam.

In another embodiment, the present disclosure provides a method for controlling Ambrosia artemisiifolia, wherein the method comprises applying an effective amount of a herbicidal combination/composition comprising asulam.

In another embodiment, the present disclosure provides a method for controlling Megathyrsus maximus, wherein the method comprises applying an effective amount of a herbicidal combination/composition comprising asulam.

According to an embodiment, the weeds, which are resistant to herbicides such as glyphosate, haloxyfop and clethodim can be effectively controlled by applying an effective amount of a herbicidal combination/composition comprising asulam.

In an embodiment, the weeds, which are resistant to herbicides such as glyphosate, haloxyfop and clethodim can be effectively controlled, at about 30 to about 58 days after application (DAA) of an effective amount of a herbicidal combination/composition comprising asulam.

In an embodiment, the herbicidal combination/composition comprising asulam are applied to a plant, or a plant propagation material, or a locus thereof, in an effective amount. The selection of the effective amount depends on the density of weed infestation, weather patterns, crop health, etc.

According to an embodiment, the present disclosure provides a method for controlling weeds in crops comprising rice, wheat, barley, rye, oat, sorghum, cotton, soybean, peanut, buckwheat, beet, rapeseed, sunflower, durum wheat, fall wheat, field corn, winter barley, cotton, fall barley, fallow, spring wheat, triticale, winter wheat, sugar cane, tobacco, etc.; vegetables; solanaceous vegetables such as eggplant, tomato, pimento, popper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc., liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc. strawberry, sweet potato, Dioscorea japonica, colocasia, etc., flowers, foliage plants, turf grasses, fruits: pome fruits such apple, pear, quince, etc. stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees otter than fruit trees; tea, mulberry, flowering plant, trees such as ash, birch, dogwood, Eucalyptus, Ginkgo biloba, lilac, maple, Quercus, poplar, Judas tree, liquidambar formosana, plane tree, zelkova. Japanese arborvitae, fir wood, hemlock, juniper, Pinus, Picea, and Taxus cuspidate, and combinations thereof.

In a preferred embodiment, the present disclosure provides a method for controlling weeds in crops comprising row crops comprising sunflower, potato, canola, dry bean, field pea, flax, safflower, buckwheat, cotton, maize, soybeans, sugar beets, and combinations thereof.

In a preferred embodiment, the present disclosure provides a method for controlling weeds in crops comprising sugarcane, soybean, wheat, maize, corn, cotton, rice, peanut, wheat, barley, and combinations thereof.

According to an embodiment of the present disclosure, the herbicidal combination/composition comprising asulam is usually applied to the unwanted plants/weeds by spraying on the leaves. Here, the application can be carried out using, for example, water as carrier by customary spraying techniques.

In an embodiment, the application of the herbicidal combination/composition comprising asulam may be done before, during and/or after, preferably before and/or after, the sowing of the crops.

In an embodiment, the application of the herbicidal combination/composition comprising asulam may be done on fallow field. In an embodiment, the application of the herbicidal combination/composition comprising asulam may be done as a burndown application.

In a preferred embodiment, the application of the herbicidal combination/composition comprising asulam may be done to control the growth of weeds at the pre-emergence stage or the post-emergence stage.

In a preferred embodiment, the application of the herbicidal combination/composition comprising asulam may be done to control the growth of weeds close to the sowing stage of the crop.

In an embodiment, the application of the herbicidal combination/composition comprising asulam may be done during fallow period or at the weeds post-emergence stage.

According to an embodiment of the present disclosure, the herbicidal combination/composition comprising asulam may be applied pre- or post-emergence of weeds, or together with the plant, or plant propagation material, or locus of a plant thereof. It is also possible to apply the herbicidal combination/composition comprising asulam to a plant, or a plant propagation material, or a locus thereof or pre-treating a crop plant with the herbicidal combination/composition comprising asulam.

According to an embodiment, the present disclosure provides use of a carbamate herbicide for controlling weeds, wherein the weeds comprise broadleaf and grass weeds.

In an embodiment, the present disclosure provides use of a herbicidal combination/composition comprising asulam, for controlling herbicide-resistant and/or herbicide-tolerant weeds.

In an embodiment, the present disclosure provides use of a herbicidal combination/composition comprising asulam, for improving yield of the desired crop.

In another embodiment, the herbicidal combination/composition of the present disclosure may be applied in combination with agrochemically active components such as fertilizers, macronutrients, micronutrients, biologicals, biostimulants, plant extracts, synergists, and combinations thereof.

In an embodiment, the macronutrients or a micronutrient is selected from the group comprising nitrogen, phosphorus, potassium, calcium, sulfur, magnesium, iron, zinc, copper, boron, manganese, chlorine, molybdenum, nickel, and combinations thereof.

In another embodiment, the additional herbicide/agrochemical may be admixed with an adjuvant or a bio-stimulant or an agrochemical or a fertilizer compound such that said components may be tank mixed before spraying.

According to an embodiment, the herbicidal combination/composition comprising asulam is applied from a pre-dosage device, a knapsack sprayer, a spray tank, a spray plane, or an irrigation system, or a drone, or an spot spray system. Typically, the herbicidal composition is made up with water, buffer, and/or further auxiliaries to the desired application concentration and the ready-to-use spray liquor or the herbicidal combination/composition comprising asulam is thus obtained.

In another embodiment, the herbicidal combination/composition comprising asulam may be used for foliar application, application to a ground, or to the soil, or to a plant, or a locus or a plant propagation material, or combinations thereof.

In another embodiment, the herbicidal combination/composition comprising asulam can be used in agricultural lands such as fields, paddy fields, lawns and orchards or in non-agricultural lands, fallow fields, or for the purpose of chemical fallow application.

According to an embodiment, the present disclosure provides a process for preparing a herbicidal composition comprising asulam and at least one agrochemically acceptable excipient thereof; wherein the process comprises mixing asulam and at least one agriculturally acceptable excipient homogenously to form the herbicidal composition.

In another embodiment, the process comprises optionally adding an additional agrochemical/herbicide.

According to an embodiment, the various components of the herbicidal combination/composition comprising asulam may be used individually or already partially or completely mixed with one or more to prepare the herbicidal combination/composition. It is also possible for the components to be separately packaged and used as a component in a kit of parts.

In one embodiment, the kits may include one or more of the components that are used to prepare the herbicidal combination/composition comprising asulam. For examples, the kits may include active ingredients and/or at least one agrochemically acceptable excipient. One or more of the components may already be combined together or pre-formulated.

According to an embodiment of the present disclosure, a kit comprising the herbicidal combination/composition comprising asulam is provided. The kit comprises a plurality of components, including at least one of the ingredients of the herbicidal combination/composition comprising asulam.

In one embodiment of the present disclosure, the kit includes at least one, or all of components needed to prepare the herbicidal combination/composition comprising asulam. For example, the kit may include asulam and at least one agrochemically acceptable excipient. The kit may optionally include an additional agrochemical or an additional herbicide.

One or more of the components may already be combined together or pre-formulated. In those embodiments where more than two components are provided in a kit, the components may already be combined and as such are packaged in a single container such as a vial, bottle, can, pouch, bag and/or canister. In other embodiments, two or more components of a kit may be packaged separate from one another, i.e., they are not pre-formulated. As such, a kit may include one or more separate containers such as vials, cans, bottles, pouches, bags and/or canisters, each container containing a separate component of the herbicidal combination/composition comprising asulam.

In both forms, an individual component of the kit may be applied separate from or together with the other components of the kit or as a component of the herbicidal combination/composition comprising asulam.

The disclosure also provides a kit comprising the herbicidal combination/composition comprising asulam for controlling weed growth or for improving yield of desired crop and instructions for use. The instructions for use typically comprise instructions for the application of the herbicidal combination/composition comprising asulam to a plant, or a locus, or a plant propagation material thereof.

According to an embodiment, the kit of parts comprises:
(a) asulam; and
(b) at least one adjuvant;
and optionally further comprises:
(c) instructions for use.

According to an embodiment, the kit of parts comprises:
(a) asulam; and
(b) at least one agrochemically acceptable excipient;
and optionally further comprises:
(c) instructions for use.

In a preferred embodiment, the kit of parts comprises:
(a) asulam;
(b) at least one agriculturally acceptable excipient; and
(c) optionally an additional agrochemical;
and optionally further comprises:
(d) instructions for use.

In a preferred embodiment, the kit of parts comprises:
(a) asulam;
(b) at least one agriculturally acceptable excipient; and
(c) optionally an additional herbicide;
and optionally further comprises:
(d) instructions for use.

According to an embodiment of the present disclosure, the herbicidal combination/composition comprising asulam of the present disclosure is stable, over time and at various temperatures.

In an embodiment of the present disclosure, the herbicidal combination/composition comprising asulam preferably retains its physical integrity during handling and spreading, and, upon broadcasting, typically releases the active ingredients when contacting fallow field, wet soil, irrigation water, or rainfall hits the broadcasting granules.

In an embodiment, the herbicidal combination/composition comprising asulam may provide synergistic control for weeds at pre-emergent and/or at post-emergent stage. In another embodiment, the herbicidal combination/composition comprising asulam may be synergistic and effective in improving yield of desired crop by controlling weeds. The herbicidal combination/composition comprising asulam also provides increase in crop yield and crop quality.

In view of the above, it will be seen that the several advantages of the disclosure are achieved, and other advantageous results attained. Although the present disclosure has been disclosed in full, it will be understood that numerous additional modifications and variations could be made thereto without departing from the scope of the disclosure.

The present disclosure is more particularly described in the following examples that are intended as illustration only, since numerous modifications and variations within the scope of the present disclosure will be apparent to those skilled in the art. The following examples illustrate the basic methodology and versatility of the present disclosure. It will be understood that the specification and examples are illustrative but not limitative of the present disclosure and that other embodiments within the spirit and scope of the disclosure will suggest themselves to those skilled in the art. Other embodiments can be practiced that are also within the scope of the present disclosure. The following examples illustrate the disclosure, but by no means intend to limit the scope of the claims.

### EXAMPLES

### Example 1: Efficacy of Asulam for Control of Ipomoea hederifolia Weed

The effect of application of asulam alone, asulam along with an adjuvant, and asulam along with an additional herbicide was observed on the growth of Ipomoea hederifolia weed at 42, 49, 56 and 63 DAA (days after application). The percentage (%) control of weeds was evaluated to assess the efficacy of the compositions and the same has been disclosed in Table 1. Untreated control was also compared, wherein no herbicidal composition was applied and thus, no control of weeds was observed.

TABLE 1

| | | | Control of | | |
|---|---|---|---|---|---|
| | | Rate of | Ipomoea hederifolia | | |
| Sr. | | application | 42 | 49 | 56 |
| No. | Treatment | (g a.i/ha) | DAA | DAA | DAA |
| 1 | Untreated | — | 0 | 0 | 0 |
| 2 | Asulam (750 g/L) | 4500 | 13.8 | 11.3 | 8.8 |
| 3 | Asulam (750 g/L) + | 4500 + | 66.3 | 83.8 | 83.8 |
| | adjuvant (200 g/L) | 15 | | | |
| 4 | Asulam (750 g/L) + | 4500 + | 28.8 | 22.5 | 18.8 |
| | Pyroxasulfone | 125 | | | |
| | (500 g/L) | | | | |

### Example 2: Efficacy of Asulam for Control of Raphanus raphanistrum Weed

The effect of application of asulam alone, asulam along with an adjuvant, and asulam along with an additional herbicide was observed on the growth of Raphanus raphanistrum weed at 42, 49, 56 and 63 DAA (days after application). The percentage (%) control of weeds was evaluated to assess the efficacy of the compositions and the same has been disclosed in Table 2. Untreated control was also compared, wherein no herbicidal composition was applied and thus, no control of weeds was observed.

TABLE 2

| | | | Control of | | |
|---|---|---|---|---|---|
| | | Rate of | Raphanus raphanistrum | | |
| Sr. | | application | 42 | 49 | 56 |
| No. | Treatment | (g a.i/ha) | DAA | DAA | DAA |
| 1 | Untreated | — | 0 | 0 | 0 |
| 2 | Asulam (750 g/L) | 4500 | 71.3 | 68.8 | 66.3 |
| 3 | Asulam (750 g/L) + | 4500 + | 62.5 | 81.3 | 85.0 |
| | adjuvant (200 g/L) | 15 | | | |
| 4 | Asulam (750 g/L) + | 4500 + | 81.3 | 76.3 | 71.3 |
| | Pyroxasulfone | 125 | | | |
| | (500 g/L) | | | | |

### Example 3: Efficacy of Asulam for Control of Avena Strigose Weed

The effect of application of asulam alone, asulam along with an adjuvant, and asulam along with an additional herbicide was observed on the growth of Avena strigose weed at 42, 49, 56 and 63 DAA (days after application). The percentage (%) control of weeds was evaluated to assess the efficacy of the compositions and the same has been disclosed in Table 3. Untreated control was also compared, wherein no herbicidal composition was applied and thus, no control of weeds was observed.

TABLE 3

| | | Rate of | Control of Avena strigose | | |
|---|---|---|---|---|---|
| Sr. | | application | 42 | 49 | 56 |
| No. | Treatment | (g a.i/ha) | DAA | DAA | DAA |
| 1 | Untreated | — | 0 | 0 | 0 |
| 2 | Asulam (750 g/L) | 4500 | 47.5 | 43.8 | 37.5 |
| 3 | Asulam (750 g/L) + | 4500 + | 47.5 | 65.0 | 82.5 |
| | adjuvant (200 g/L) | 15 | | | |
| 4 | Asulam (750 g/L) + | 4500 + | 75.0 | 72.5 | 70.0 |
| | Pyroxasulfone | 125 | | | |
| | (500 g/L) | | | | |

### Example 4: Efficacy of Asulam for Control of Ambrosia artemisifolia Weed

The effect of application of asulam was observed on the growth of Ambrosia artemisifolia weed at 28, 35 and 49 DAA (days after application) at different application rates. The percentage (%) control of weeds has been evaluated and disclosed in Table 4.

TABLE 4

| | | Rate of | | | |
|---|---|---|---|---|---|
| Sr. | | application | Control of Ambrosia Artemisifolia | | |
| No. | Treatment | (g a.i/ha) | 28 DAA | 35 DAA | 49 DAA |
| 1 | Asulam | 1200 | 86 | 87 | 90 |
| 2 | Asulam | 1500 | 91 | 90 | 91 |
| 3 | Asulam | 2250 | 93 | 94 | 99 |
| 4 | Asulam | 2500 | 92 | 93 | 99 |

### Example 5: Efficacy of Asulam for Control of Megathyrsus Maximus Weed

The effect of application of asulam was observed on the growth of Megathyrsus maximus weed at 14 and 21 DAA (days after application) at different application rates. The percentage (%) control of weeds has been evaluated and disclosed in Table 5.

TABLE 5

| Sr. | Treat- | Rate of application | Control of Megathyrsus maximus | |
|---|---|---|---|---|
| No. | ment | (g a.i/ha) | 14 DAA | 21 DAA |
| 1 | Asulam | 3200 | 79 | 85 |
| 2 | Asulam | 3600 | 80 | 86 |
| 3 | Asulam | 4000 | 76 | 85 |

### Example 6: Efficacy of Asulam for Control of Ipomoea hederifolia Weed

The effect of application of asulam was observed on the growth of Ipomoea hederifolia weed at 21, 28 and 35 DAA (days after application) at different application rates. The percentage (%) control of weeds has been evaluated and disclosed in Table 6.

TABLE 6

| Sr. | Treat- | Rate of application | Control of Ipomoea hederifolia | | |
|---|---|---|---|---|---|
| No. | ment | (g a.i/ha) | 21 DAA | 28 DAA | 35 DAA |
| 1 | Asulam | 1800 | 63 | 77 | 76 |
| 2 | Asulam | 2250 | 71 | 83 | 85 |
| 3 | Asulam | 2500 | 70 | 84 | 88 |

### Example 7: Efficacy of Asulam for Control of Raphanus Raphanistrum Weed

The effect of application of asulam was observed on the growth of Raphanus raphanistrum weed at 14, 21 and 28 DAA (days after application) at different application rates. The percentage (%) control of weeds has been evaluated and disclosed in Table 7.

TABLE 7

| Sr. | Treat- | Rate of application | Control of Raphanus raphanistrum | | |
|---|---|---|---|---|---|
| No. | ment | (g a.i/ha) | 14 DAA | 21 DAA | 28 DAA |
| 1 | Asulam | 1800 | 61 | 69 | 82 |
| 2 | Asulam | 2250 | 63 | 73 | 84 |
| 3 | Asulam | 2500 | 66 | 77 | 88 |

### Example 8: Efficacy of Asulam for Control of Avena Strigose Weed

The effect of application of asulam was observed on the growth of Avena strigose weed at 28, 35 and 49 DAA (days after application) at different application rates. The percentage (%) control of weeds has been evaluated and disclosed in Table 8.

TABLE 8

| Sr. | Treat- | Rate of application | Control of Avena strigose | | |
|---|---|---|---|---|---|
| No. | ment | (g a.i/ha) | 28 DAA | 35 DAA | 49 DAA |
| 1 | Asulam | 1200 | 81 | 84 | 81 |
| 2 | Asulam | 1500 | 86 | 89 | 89 |
| 3 | Asulam | 1800 | 96 | 99 | 99 |
| 4 | Asulam | 2250 | 95 | 100 | 100 |
| 5 | Asulam | 2500 | 98 | 100 | 100 |

### Example 9: Efficacy of Asulam for Control of Weeds at Pre-Emergence Stage

The effect of application of asulam was observed on the growth of weeds at pre-emergence stage for different application rates. The percentage (%) control of weeds has been evaluated and disclosed in Table 9.

TABLE 9

| | | Rate of | | Days after application | | |
|---|---|---|---|---|---|---|
| Sr. | | application | | (DAA) | | |
| No. | Treatment | (g a.i/ha) | Weed(s) | 28 | 35 | 49 |
| 1 | Asulam | 1000 | Digitaria insularis | 94 | 98 | 100 |
| 2 | Asulam | 1200 | Digitaria insularis | 98 | 100 | 100 |
| 3 | Asulam | 1500 | Digitaria insularis | 99 | 100 | 100 |
| 4 | Asulam | 1800 | Digitaria insularis | 99 | 100 | 100 |
| 5 | Asulam | 2250 | Digitaria insularis | 100 | 100 | 100 |
| 6 | Asulam | 2500 | Digitaria insularis | 99 | 100 | 100 |
| 7 | Asulam | 1200 | Eleusine indica | 83 | 78 | 99 |
| 8 | Asulam | 1500 | Eleusine indica | 88 | 88 | 99 |
| 9 | Asulam | 1800 | Eleusine indica | 90 | 91 | 100 |
| 10 | Asulam | 2250 | Eleusine indica | 92 | 93 | 100 |
| 11 | Asulam | 2500 | Eleusine indica | 91 | 92 | 100 |

### Example 10: Efficacy of Asulam for Control of Weeds at Post-Emergence Stage

The effect of application of asulam was observed on the growth of weeds at post-emergence stage for different application rates. The percentage (%) control of weeds has been evaluated and disclosed in Table 10.

TABLE 10

| | | Rate of | | Days after application | | |
|---|---|---|---|---|---|---|
| Sr. | | application | | (DAA) | | |
| No. | Treatment | (g a.i/ha) | Weed(s) | 28 | 35 | 49 |
| 1 | Asulam | 2400 | Cynodon dactylon | 94 | 97 | 99 |
| 2 | Asulam | 2800 | Cynodon dactylon | 96 | 97 | 100 |
| 3 | Asulam | 3200 | Cynodon dactylon | 94 | 94 | 96 |
| 4 | Asulam | 4000 | Cynodon dactylon | 95 | 96 | 100 |
| 5 | Asulam | 2800 | Digitaria nuda | 99 | 99 | 99 |
| 6 | Asulam | 3200 | Digitaria nuda | 96 | 100 | 100 |
| 7 | Asulam | 4000 | Digitaria nuda | 93 | 94 | 94 |
| 8 | Asulam | 1000 | Bidens pilosa | 100 | 100 | 100 |
| 9 | Asulam | 1500 | Bidens pilosa | 100 | 100 | 100 |
| 10 | Asulam | 1800 | Bidens pilosa | 94 | 97 | 97 |
| 11 | Asulam | 2250 | Bidens pilosa | 93 | 95 | 94 |
| 12 | Asulam | 1800 | Brachiaria plantaginea | 92 | 92 | 83 |
| 13 | Asulam | 2250 | Brachiaria plantaginea | 95 | 88 | 73 |
| 14 | Asulam | 2500 | Brachiaria plantaginea | 93 | 92 | 100 |

1. A method for controlling weeds by applying an effective amount of a carbamate herbicide, wherein the weeds comprise broadleaf and grass weeds.

2. The method as claimed in claim 1, wherein the weeds are selected from the group comprising Avena strigosa, Ipomoea hederifolia, Raphanus raphanistrum, Ambrosia artemisifolia, Megathyrsus maximus, Digitaria insularis, Eleusine indica, Cynodon dactylon, Digitaria nuda, Bidens Pilosa, Brachiaria plantaginea, and combinations thereof.

3. The method as claimed in claim 1, wherein the weeds are controlled from about 10% to about 100% by applying an effective amount of the carbamate herbicide.

4. The method as claimed in claim 1, wherein the carbamate herbicide is asulam.

5. The method as claimed in claim 4, wherein the asulam is applied at an application rate ranging from about 10 g a.i./ha to about 3000 g a.i./ha.

6. The method as claimed in claim 1, wherein the method further comprises applying an effective amount of a herbicidal combination comprising:
asulam; and
an adjuvant.

7. The method as claimed in claim 6, wherein the asulam and the adjuvant are present in a weight ratio from about 1:30 to about 30:1.

8. The method as claimed in claim 1, wherein the method further comprises applying an effective amount of a herbicidal combination comprising:
asulam; and
an additional herbicide.

9. The method as claimed in claim 8, wherein the asulam and the additional herbicide are present in a weight ratio from about 1:30 to about 30:1.

10. The method as claimed in claim 8, wherein the additional herbicide is selected from the group comprising pyroxasulfone, glufosinate, glufosinate-P, flucarbazone, mesotrione, propanil, napropamide, napropamide-M, quizalofop, quizalofop-P, haloxyfop, haloxyfop-P, topramezone, saflufenacil, amicarbazone, metolachlor, S-metolachlor, pendimethalin, clomazone, glyphosate, paraquat, clethodim, triclopyr, or combinations thereof

11. The method as claimed in claim 1, wherein the method further comprises applying an effective amount of a herbicidal composition comprising:
asulam; and
at least one agrochemically acceptable excipient thereof.

12. The method as claimed in claim 11, wherein the composition comprises asulam in an amount from about 50% w/w to about 85% w/w and the at least one agrochemically acceptable excipient in an amount from about 1% w/w to about 30% w/w of total weight of the composition.

13. The method as claimed in claim 11, wherein the herbicidal composition is in a form of a soluble concentrate or a water dispersible granule.

14. (canceled)
